(19) United States
(12) Patent Application Publication
(10) Pub. No.: US 2026/0355951 A1
(43) Pub. Date: Nov. 12, 2026

(54) ROBOT SYSTEM AND CONTROL METHOD

(71) Applicant: KABUSHIKI KAISHA YASKAWA DENKI, Kitakyushu-shi (JP)

(72) Inventors: Arata TAKAKI, Kitakyushu-shi (JP); Yoshihide YAMATO, Kitakyushu-shi (JP); Yoshifumi ONOYAMA, Kitakyushu-shi (JP); Yukio HASHIGUCHI, Kitakyushu-shi (JP)

(73) Assignee: KABUSHIKI KAISHA YASKAWA DENKI, Kitakyushu-shi (JP)

(21) Appl. No.: 19/658,710

(22) Filed: Apr. 27, 2026

(30) Foreign Application Priority Data
May 7, 2025 (JP) 2025-077216

(51) Int. Cl. B25J 9/16

(52) U.S. Cl. CPC B25J 9/1641; B25J 9/1664

(57) ABSTRACT

A robot system includes a robot having an arm configured to change a position of an end effector, a processor, and a memory. The memory stores first information representing a structural characteristic of the arm that causes a motion error of the robot in a first operating region. The memory stores instructions that when executed by the processor, cause the processor to perform operations comprising controlling the robot so as to reduce the motion error based on the first information when the robot operates within the first operating region.

### CROSS-REFERENCE TO RELATED APPLICATIONS

The present application claims priority under 35 U.S.C. §119 to Japanese Patent Application No. 2025-077216, filed May 7, 2025. The contents of this application are incorporated herein by reference in their entirety.

### BACKGROUND

### Technical Field

The present disclosure relates to a robot system and a control method.

### Background Art

Japanese Unexamined Patent Application Publication No. 2019-198925 discloses a control system comprising a controller and an operation device. The operation device acquires an operation input by an operator, generates a command based on the operation input, and outputs the command to the controller. The controller controls a robot in accordance with the command from the operation device.

### SUMMARY

According to one aspect of the present disclosure, a robot system includes a robot having an arm configured to change a position of an end effector, a processor, and a memory. The memory stores first information representing a structural characteristic of the arm that causes a motion error of the robot in a first operating region. The memory stores instructions that when executed by the processor, cause the processor to perform operations comprising controlling the robot so as to reduce the motion error based on the first information when the robot operates within the first operating region.

According to another aspect of the present disclosure, a computer-implemented control method includes reading first information from a memory, the first information representing a structural characteristic of an arm of a robot that causes a motion error of the robot in a first operating region. The method includes controlling the robot so as to reduce the motion error based on the selected first information when the robot operates within the first operating region.

According to further aspect of the present disclosure, a robot system includes a robot having an arm configured to change a position of an end effector. The robot system includes storage means for storing first information representing a structural characteristic of the arm that causes a motion error of the robot in a first operating region. The robot system includes control means for controlling the robot so as to reduce the motion error based on the first information when the robot operates within the first operating region.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a schematic diagram illustrating a configuration of a robot system.

FIG. 2 is a schematic diagram illustrating a correction of a position command.

FIGS. 3A and 3B are schematic diagrams illustrating a selection of characteristic information.

FIGS. 4A and 4B are schematic diagrams illustrating a selection of characteristic information.

FIG. 5 is a schematic diagram illustrating a definition of an operating region.

FIG. 6 is a schematic diagram showing a modified example of a definition of an operating region.

FIG. 7 is a schematic diagram showing another modified example of a definition of an operating region.

FIG. 8 is a schematic diagram showing still another modified example of a definition of an operating region.

FIG. 9 is a schematic diagram showing still another modified example of a definition of an operating region.

FIG. 10 is a schematic diagram showing a modified example of a robot system.

FIG. 11 is a schematic diagram illustrating generation of a motion path.

FIG. 12 is a schematic diagram showing another modified example of a robot system.

FIG. 13 is a schematic diagram illustrating generation of characteristic information.

FIG. 14 is a block diagram illustrating a hardware configuration of a robot controller.

FIG. 15 is a flowchart illustrating a control procedure of a robot.

FIG. 16 is a flowchart illustrating a selection procedure of characteristic information.

FIG. 17 is a flowchart illustrating a generation procedure of a motion path.

FIG. 18 is a flowchart illustrating a generation procedure of characteristic information.

### DESCRIPTION OF THE EMBODIMENTS

Hereinafter, embodiments will be described in detail with reference to the drawings. In the description, the same elements or elements having the same function are denoted by the same reference numerals, and redundant description will be omitted.

### Robot System

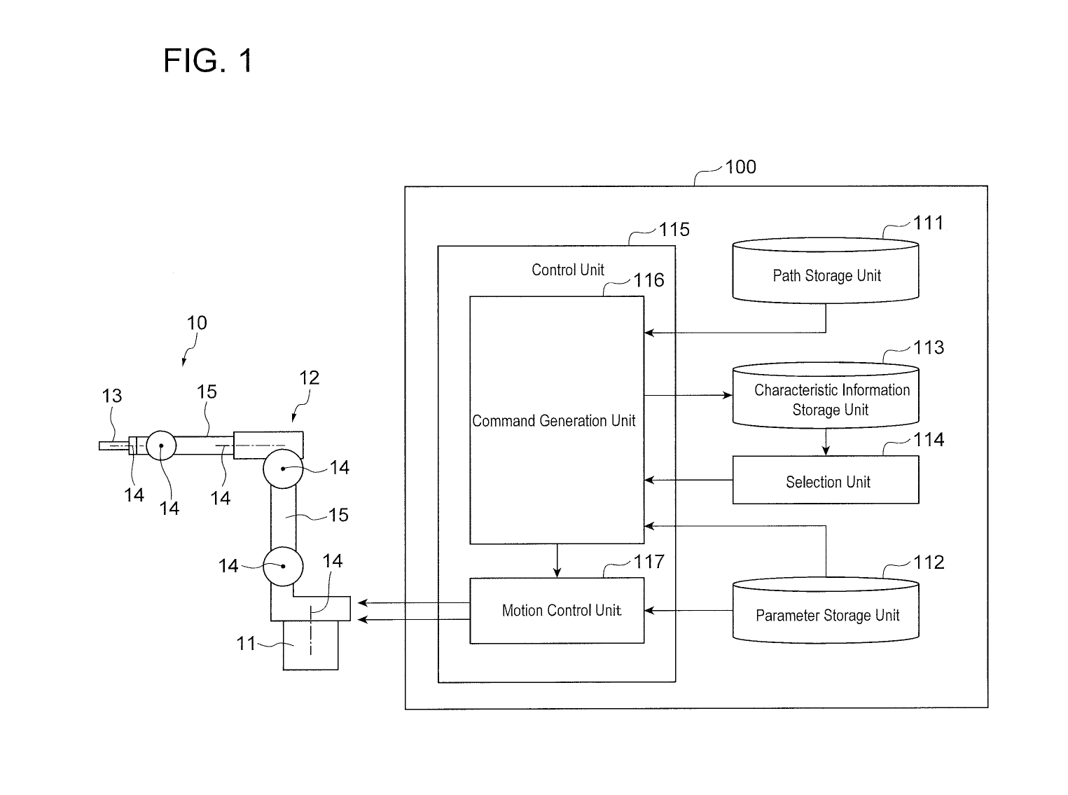

The robot system 1 shown in FIG. 1 is a system that causes a robot 10 to execute a task. Examples of the task include a task on a workpiece, such as conveyance of a workpiece, processing on a workpiece, and assembly of a workpiece. The workpiece is an object to be worked on by the robot 10. The workpiece may be a single part, or may be an assembly in which a plurality of parts are combined. Examples of the processing on the workpiece include grinding of a part, polishing of a part, and the like. Examples of the assembly of the workpiece include fastening of a plurality of parts to each other by bolt fastening or the like, joining of a plurality of parts to each other by welding or the like.

As shown in FIG. 1, the robot system 1 comprises a robot 10 and a robot controller 100. The robot 10 is, for example, an industrial vertical articulated robot, and has a base 11, an arm 12, and an end effector 13. The base 11 is fixed to a floor surface, a wall surface, or a ceiling surface of a workplace by the robot 10. The arm 12 is a serial link type having a plurality of (for example, six axes) joints 14, and is connected to the base 11. The end effector 13 is connected to an end of the arm 12, and acts on the workpiece in a task by the robot 10. The arm 12 changes a position of the end effector 13 by moving the plurality of joints 14. Changing the position of the end effector 13 includes changing a posture of the end effector 13.

Examples of the end effector 13 include a holding tool, a processing tool, an assembly tool, and the like. Examples of the holding tool include a hand that holds a workpiece, a suction nozzle that applies suction to a workpiece, and the like. Examples of the processing tool include a cutting tool, a grinding tool, a painting tool, and the like. Examples of the assembly tool include a screw tightening tool, a crimping tool, a welding tool, and the like.

The configuration of the robot 10 is not limited to the above examples. For example, the robot 10 may be a redundant robot further having one or more joints 14 constituting a redundant degree of freedom in addition to the six-axis joints 14. The redundant degree of freedom is a degree of freedom that enables freely changing the angles of the plurality of joints 14 corresponding to the position and posture of the end effector 13 without being limited to a finite number of solutions. The robot 10 may be an AMR (Autonomous Mobile Robot) that can move autonomously. In the AMR, an automated guided vehicle that enables the robot 10 to move also constitutes the above-described redundant degree of freedom. The robot 10 may be a parallel link type or may be a SCARA type.

The robot controller 100 controls the robot 10 so as to execute a task. For example, the robot controller 100 controls the arm 12 by the arm 12 so as to arrange the end effector 13 at a target position. The target position is designated by, for example, a motion command generated in advance. The target position includes a target posture.

The motion command can be generated by offline teaching that programs a motion of the robot within a simulation environment. However, in a real environment, a motion error relative to the target position may occur due to a structural characteristic of the robot 10 that is not reproduced in the simulation environment. Therefore, the robot controller 100 stores information representing the structural characteristic of the arm 12, and operates the robot 10 so as to reduce the motion error based on the stored information. For example, the robot controller 100 calculates a motion error occurring relative to the target position due to the structural characteristic based on the stored information, and controls each of the plurality of joints 14 so as to reduce the calculated motion error. Examples of the structural characteristic include a dimensional error, compliance (flexibility) of the arm 12, and the like. In addition to these, any structural characteristic that becomes a factor of a motion error is included in the structural characteristic.

The structural characteristic may change depending on an operation region of the robot 10. For example, the compliance of the joint 14 may change depending on the magnitude of a moment acting on the joint 14. Further, the compliance of the joint 14 may also change depending on an operation angle of the joint 14. Therefore, the robot controller 100 is configured to execute storing first information representing the structural characteristic of the arm 12 in a first operating region, selecting the first information when the robot 10 operates within the first operating region, and operating the robot 10 so as to reduce the motion error based on the selected first information. By using the first information specialized for the first operating region, it is possible to further reduce the motion error in the first operating region.

For example, the robot controller 100 has a path storage unit 111, a parameter storage unit 112, a characteristic information storage unit 113 (storage unit), and a selection unit 114 as functional components (hereinafter referred to as "functional blocks"). The path storage unit 111 stores a motion path programmed in advance. The motion path includes a plurality of motion commands arranged in chronological order. Each of the plurality of motion commands includes information defining the target position of the end effector 13. The information defining the target position of the end effector 13 may be a numerical value directly defining the target position of the end effector 13 itself, or may be a numerical value indirectly defining the target position of the end effector 13. An example of the numerical value indirectly defining the target position of the end effector 13 includes a numerical value defining a target angle of each of the plurality of joints 14.

The parameter storage unit 112 stores a kinematic parameter of the robot 10. The kinematic parameter is, for example, a DH (Denavit-Hartenberg) parameter. For example, the arm 12 includes a plurality of links 15 connected by the plurality of joints 14. The kinematic parameter includes at least an arrangement order of the plurality of joints 14 and the plurality of links 15, and a length of each of the plurality of links 15. The parameter storage unit 112 may further store a dynamic parameter of the robot 10. The dynamic parameter further includes weight information of each part of the robot 10.

The characteristic information storage unit 113 stores the first information representing the structural characteristic of the arm 12 in the first operating region. The first information may include information indicating compliance of the arm 12 in the first operating region. By using the compliance specialized for the first operating region, it is possible to further reduce the motion error in the first operating region even when there is nonlinearity in the compliance.

The compliance means mechanical flexibility of the arm 12. The information indicating the compliance is not necessarily limited to information directly indicating the compliance, and includes information indirectly indicating the compliance. An example of the information indirectly indicating the compliance includes rigidity, which is a characteristic opposite to compliance.

The selection unit 114 selects the first information when the robot 10 operates within the first operating region. That the robot 10 operates within the first operating region includes that a current state of the robot 10 during the operation actually falls within the first operating region, and also includes that a target position of a currently executed operation falls within the first operating region.

The control unit 115 operates the robot 10 so as to reduce the motion error, based on the selected first information. For example, the control unit 115 generates a position command in which a component for canceling the motion error is added to the target position, and controls the robot 10 so as to track the position command.

For example, the control unit 115 has a command generation unit 116 and a motion control unit 117. The command generation unit 116 sequentially generates a position command representing a waypoint of the robot 10 up to the target position so as to reduce the motion error, based on the target position defined by the motion command and the first information. The waypoint includes a position passed through before reaching the target position, and the target position itself. The motion control unit 117 controls the robot 10 by the sequentially generated position commands. For example, the command generation unit 116 and the motion control unit 117 repeat the generation of the position command and the control of the robot 10 by the position command at a predetermined control cycle (for example, 10 ms or less). By reducing the motion error for each control cycle, the motion error can be reduced even on an intermediate route to the target position.

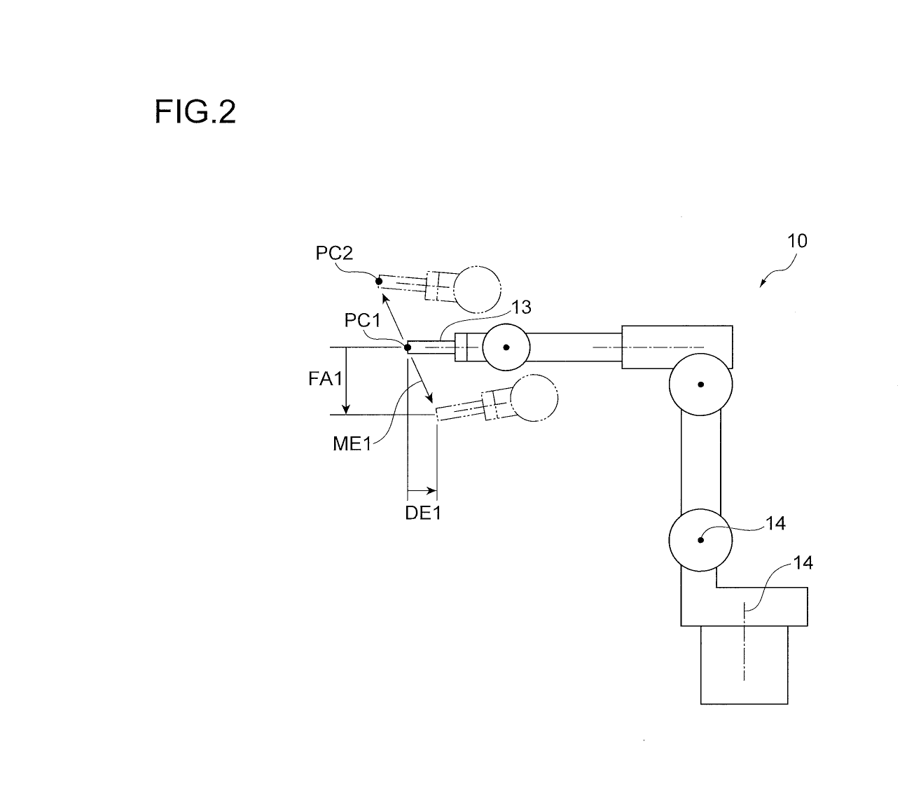

The generation of the position command by the command generation unit 116 will be exemplified with reference to FIG. 2. In each cycle repeated in the control cycle, the command generation unit 116 generates a provisional position command PC1 based on the target position. For example, the command generation unit 116 generates the provisional position command PC1 including a cycle target position and a cycle target posture of a hand, based on a current position and a current posture of the end effector 13, a target position and a target posture of the end effector 13 designated by the target position, and a predetermined interpolation method. The interpolation method is defined by, for example, the motion command. The cycle target position and the cycle target posture are a target position and a target posture of the end effector 13 at a time point when the cycle is completed.

The command generation unit 116 calculates a deflection FA1 of the robot 10 based on the provisional position command PC1, the compliance of the robot 10 included in the first information, and the kinematic parameter and the dynamic parameter of the robot 10 stored in the parameter storage unit 112. For example, the command generation unit 116 calculates a moment acting on each of the plurality of joints 14 based on the provisional position command PC1, the kinematic parameter, and the dynamic parameter, and calculates a deflection occurring in each of the plurality of joints 14 based on the calculated moment and the compliance of each of the plurality of joints 14. Furthermore, the command generation unit 116 calculates a displacement vector of the hand due to the deflection as a motion error ME1 based on the deflection occurring in each of the plurality of joints 14 and the kinematic parameter.

The command generation unit 116 generates a position command PC2 based on the motion error ME1 and the provisional position command PC1. For example, the command generation unit 116 generates the position command PC2 so as to reduce the motion error ME1. For example, the command generation unit 116 generates the position command PC2 so as to cancel the deflection FA1 by adding a vector having a direction opposite to that of the motion error ME1 and the same magnitude as the motion error ME1 to the provisional position command PC1. The motion error caused by the deflection can be reduced with high accuracy.

The command generation unit 116 may generate the position command PC2 based on the provisional position command PC1, a dimensional error DE1, and the deflection FA1. For example, the command generation unit 116 calculates a displacement vector of the hand caused by the dimensional error as the dimensional error DE1 based on the kinematic parameter and the dimensional error. The displacement vector here is a vector directing from the hand when there is no dimensional error to the hand when there is a dimensional error. The command generation unit 116 generates the position command PC2 so as to reduce a motion error ME1 combining the deflection FA1 and the dimensional error DE1. For example, the command generation unit 116 generates the position command PC2 so as to cancel the deflection FA1 by adding a vector having a direction opposite to that of the motion error ME1 and the same magnitude as the motion error ME1 to the provisional position command PC1.

The command generation unit 116 may reflect a dimensional error in the deflection FA1. For example, the command generation unit 116 may calculate the deflection FA1 further based on the dimensional error in addition to the provisional position command PC1, the kinematic parameter, and the dynamic parameter. By reflecting the dimensional error in the deflection FA1, it is possible to calculate the deflection FA1 with higher accuracy.

The dimensional error may be reflected in advance in the kinematic parameter. In this case, the parameter storage unit 112 constitutes a part of the characteristic information storage unit 113.

Returning to FIG. 1, the motion control unit 117 calculates a target angle of each of the plurality of joints 14 corresponding to the position command (the position command PC2 generated by the command generation unit 116) by inverse kinematics calculation based on the kinematic parameter, and controls the arm 12 so that the angle of each of the plurality of joints 14 tracks the target angle. As a result of each of the plurality of joints 14 tracking the target angle corresponding to the position command PC2 including the vector opposite in direction to the motion error ME1, the vector opposite in direction to the motion error ME1 and the motion error ME1 cancel each other out, and the motion error ME1 is reduced.

The characteristic information storage unit 113 may store second information representing a structural characteristic of the arm 12 in a second operating region, in addition to the first information. The selection unit 114 may select the first information when the robot 10 operates within the first operating region, and may select the second information when the robot 10 operates within the second operating region. The control unit 115 may operate the robot 10 so as to reduce the motion error based on the selected first information or second information. Even when the structural characteristic of the arm 12 changes depending on the operating region (for example, when there is nonlinearity in the structural characteristic of the arm 12), the motion error in the first operating region can be further reduced based on the first information for the first operating region, and the motion error in the second operating region can be further reduced based on the second information for the second operating region.

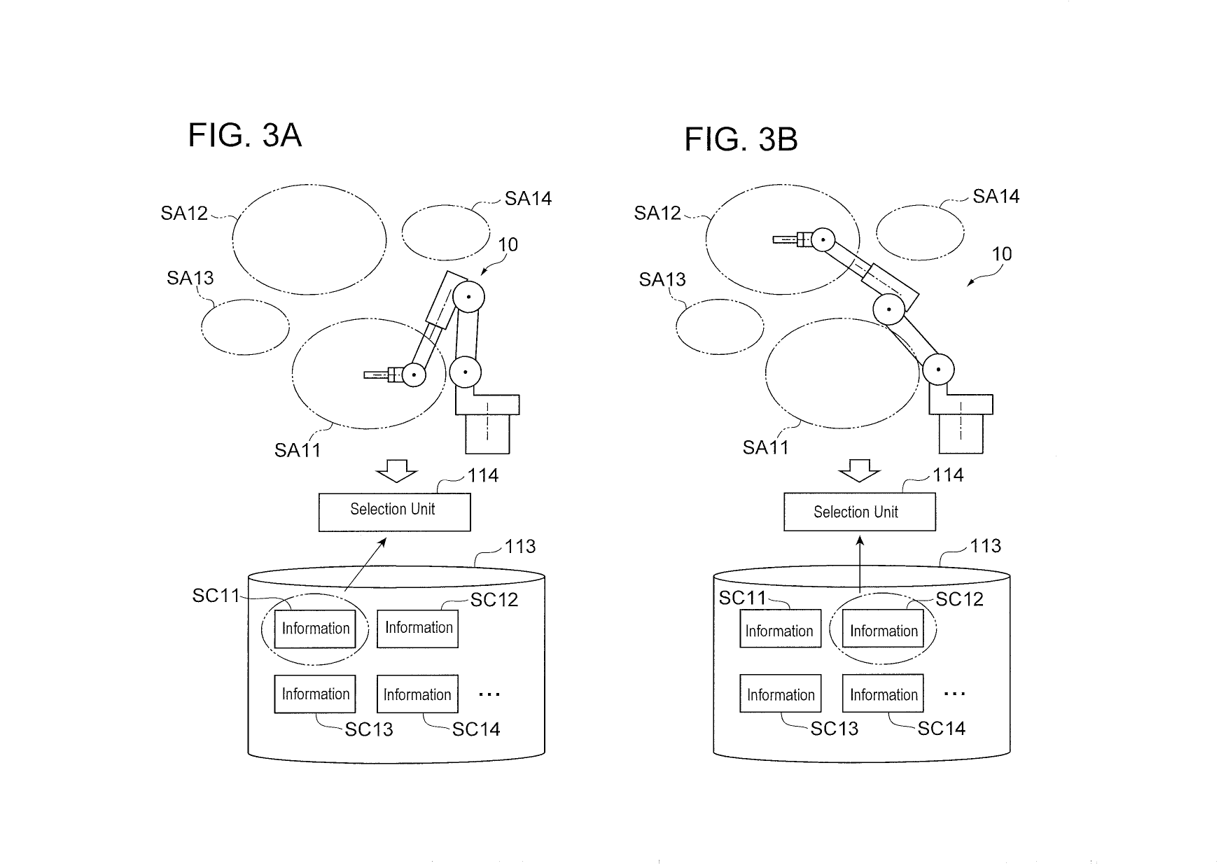

For example, as shown in FIG. 3, characteristic information SC11, SC12, SC13, and SC14 corresponding to a plurality of operating regions SA11, SA12, SA13, and SA14, respectively, are stored. The characteristic information SC11 (first information) represents a structural characteristic of the arm 12 in the operating region SA11 (first operating region). The characteristic information SC12 (second information) represents a structural characteristic of the arm 12 in the operating region SA12 (second operating region). The characteristic information SC13 (third information) represents a structural characteristic of the arm 12 in the operating region SA13 (third operating region). The characteristic information SC14 (fourth information) represents a structural characteristic of the arm 12 in the operating region SA14 (fourth operating region). Although four sets of information are illustrated in FIG. 3, the number of sets of information is not limited to this.

As shown in FIG. 3A, when the robot 10 operates within the operating region SA11, the selection unit 114 selects the characteristic information SC11. As shown in FIG. 3B, when the robot 10 operates within the operating region SA12, the selection unit 114 selects the characteristic information SC12. Although illustration is omitted, when the robot 10 operates within the operating region SA13, the selection unit 114 selects the characteristic information SC13, and when the robot 10 operates within the operating region SA14, the selection unit 114 selects the characteristic information SC14.

Hereinafter, an operating region to which specific characteristic information is associated, such as the operating regions SA11, SA12, SA13, and SA14, is collectively referred to as a "specific region SA1", and the specific characteristic information is collectively referred to as "characteristic information SC1".

The characteristic information storage unit 113 may store common information representing a structural characteristic of the arm 12, in addition to the first information. The selection unit 114 may switch the information from the common information to the first information when the robot 10 operates within the first operating region. When the selected information is switched from the common information to the first information, the control unit 115 may switch from a state of operating the robot 10 so as to reduce a motion error based on the common information to a state of operating the robot 10 so as to reduce a motion error based on the first information.

The common information is information stored in common for the entire region in which the robot 10 can operate, without being associated with a specific operating region. The entire region in which the robot 10 can operate may include a region associated with specific information (first information or second information) such as the above-described first operating region or second operating region, and a region not associated with specific information. Hereinafter, the region not associated with specific information will be collectively referred to as an "undefined region".

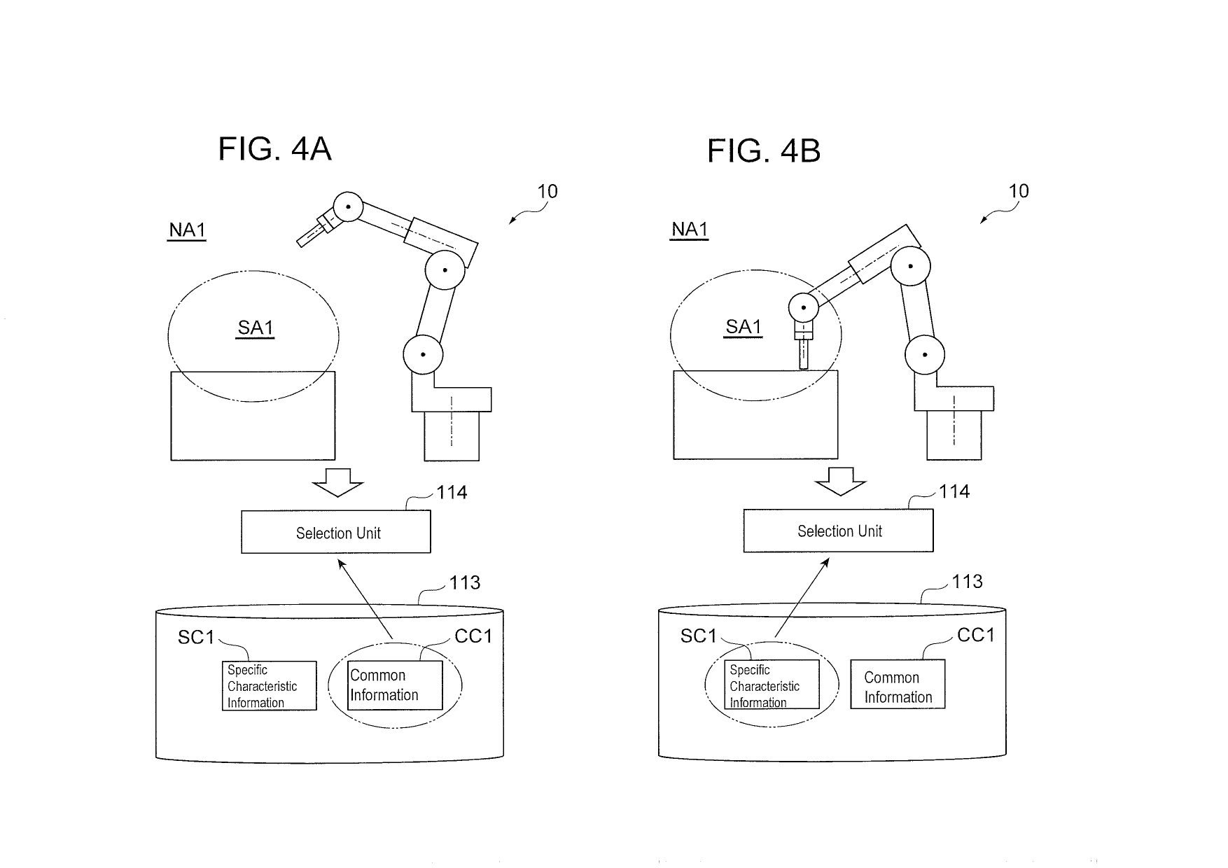

For example, as shown in FIG. 4A, when the robot 10 is in an undefined region NA1, the selection unit 114 selects the common information CC1. As shown in FIG. 4B, when the robot 10 operates within the specific region SA1, the selection unit 114 selects the specific characteristic information SC1 (switches the common information CC1 to the specific characteristic information SC1). Further, when the operation region of the robot 10 changes the specific region SA1 to the undefined region NA1, the selection unit 114 selects the common information CC1 (switches the specific characteristic information SC1 to the common information CC1). The entire region in which the robot 10 can operate may include a plurality of specific regions SA1 (for example, the above-described first operating region and second operating region). When an operation region of the robot 10 changes from a specific region SA1 to another specific region SA1, the selection unit 114 may switch the specific characteristic information SC1 selected up to that point to specific characteristic information SC1 of the other specific region SA1.

When the common information CC1 is selected, the control unit 115 operates the robot 10 so as to reduce a motion error based on the common information CC1, and when the specific characteristic information SC1 is selected, operates the robot 10 so as to reduce a motion error based on the specific characteristic information SC1. By applying the common information CC1 to an operating region to which the specific characteristic information SC1 is not associated, it is possible to reduce a motion error of the robot 10 in a wider region.

In the above description, an example in which the process of reducing a motion error is executed at a stage of actually controlling the robot 10 is shown, but the process of reducing a motion error may be executed before starting the control of the robot 10. For example, calculating a motion error based on characteristic information and correcting a motion path so as to reduce the motion error may be executed in a simulation device that generates a motion path offline. In this case, the characteristic information storage unit 113 and the selection unit 114 may be provided in a simulation device or the like. In this case, the characteristic information storage unit 113 and the selection unit 114 may be provided in a simulation device or the like. When calculating a motion error in the simulation device, the selection unit 114 selects the specific characteristic information SC1 when the robot 10 operates within the specific region SA1. The simulation device corrects the motion path so as to reduce the motion error, based on the selected specific characteristic information SC1. By being based on the motion path corrected in this way, the control unit 115 controls the robot 10 so as to reduce the motion error, based on the specific characteristic information SC1 selected by the selection unit 114.

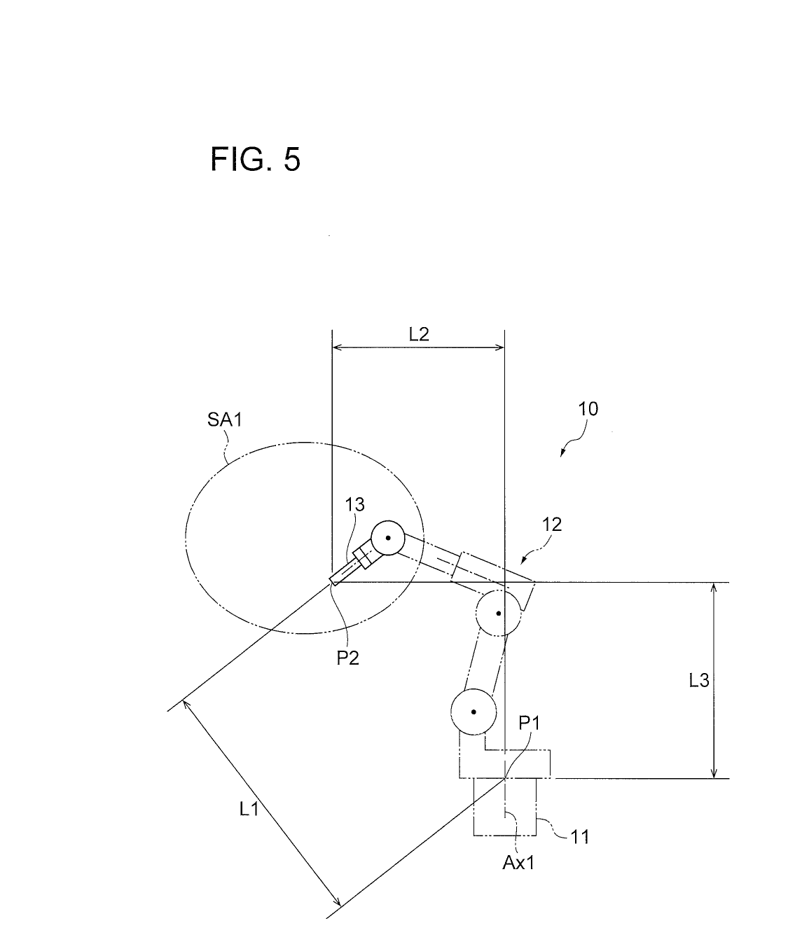

As shown in FIG. 5, the specific region SA1 may be defined by a position of the end effector 13. The selection unit 114 selects the first information when a position of the end effector 13 falls within the first operating region. The position of the end effector 13 may have a large influence on a motion error. In this case, the specific region SA1 is defined by the position of the end effector 13, and the characteristic information SC1 is selected when the position of the end effector 13 falls within the specific region SA1, whereby the motion error of the robot 10 can be easily reduced.

For example, the specific region SA1 may be represented by a region of a component indicating 3D coordinates of the end effector 13 in a predetermined coordinate system. The specific region SA1 may be represented as a function of components of 3D coordinates of the end effector 13. An inner/outer boundary of the specific region SA1 may be represented by a set such as a point cloud or polygons.

The specific region SA1 may be defined by a distance L1 from the base 11 to the end effector 13. For example, the distance L1 is a distance between a specific point P1 on the base 11 and a specific point P2 on the end effector 13. The selection unit 114 may select the characteristic information SC1 when a distance from the base 11 to the end effector 13 falls within the specific region SA1. The distance from the base 11 to the end effector 13 may have a large influence on a motion error. In this case, the specific region SA1 is defined by the distance from the base 11 to the end effector 13, and the characteristic information SC1 is selected when the distance from the base 11 to the end effector 13 falls within the specific region SA1, whereby the motion error of the robot 10 can be easily reduced.

The specific region SA1 may be defined by a distance L2 from a vertical axis Ax1 passing through the base 11 to the end effector 13. The vertical axis Ax1 is, for example, a vertical axis passing through the point P1. The vertical axis Ax1 may be a rotation center of the arm 12 with respect to the base 11. The selection unit 114 may select the characteristic information SC1 when a distance L2 from the vertical axis Ax1 passing through the base 11 to the end effector 13 falls within the specific region SA1. The distance from the vertical axis Ax1 to the end effector 13 may have a large influence on a motion error. In this case, the specific region SA1 is defined by the distance from the vertical axis Ax1 to the end effector 13, and the characteristic information SC1 is selected when the distance from the vertical axis Ax1 to the end effector 13 falls within the specific region SA1, whereby the motion error of the robot 10 can be easily reduced.

The specific region SA1 may be defined by a height L3 of the end effector 13 with respect to the base 11. The selection unit 114 may select the characteristic information SC1 when a height L3 of the end effector 13 with respect to the base 11 falls within the specific region SA1. The height of the end effector 13 with respect to the base 11 may have a large influence on a motion error. In this case, the specific region SA1 is defined by the height L3 of the end effector 13 with respect to the base 11, and the characteristic information SC1 is selected when the height L3 of the end effector 13 with respect to the base 11 falls within the specific region SA1, whereby the motion error of the robot 10 can be easily reduced.

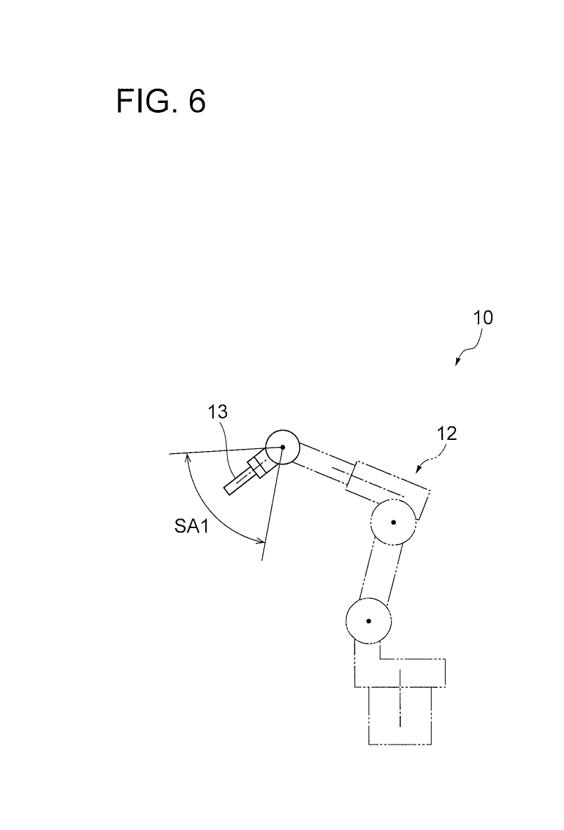

As shown in FIG. 6, the specific region SA1 may be defined by a posture of the end effector 13. The selection unit 114 may select the characteristic information SC1 when a posture of the end effector 13 falls within the specific region SA1. The posture of the end effector 13 may have a large influence on a motion error. In this case, the specific region SA1 is defined by the posture of the end effector 13, and the characteristic information SC1 is selected when the posture of the end effector 13 falls within the specific region SA1, whereby the motion error of the robot 10 can be easily reduced. For example, the specific region SA1 may be represented by a region of a component indicating a 3D posture (for example, an angle of the end effector 13 around each coordinate axis) of the end effector 13 in a predetermined coordinate system. The specific region SA1 may be represented as a function of components of a 3D posture of the end effector 13.

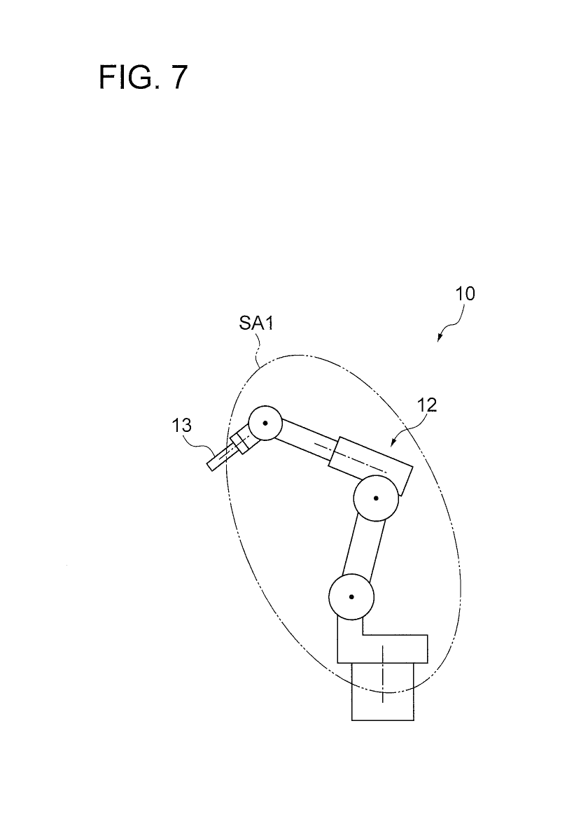

As shown in FIG. 7, the specific region SA1 may be defined by a posture of the arm 12. The selection unit 114 may select the characteristic information SC1 when a posture of the arm 12 falls within the specific region SA1. The posture of the arm 12 may have a large influence on a motion error. In this case, the specific region SA1 is defined by the posture of the arm 12, and the characteristic information SC1 is selected when the posture of the arm 12 falls within the specific region SA1, whereby the motion error of the robot 10 can be easily reduced.

The selection unit 114 may select the characteristic information SC1 when a posture of the arm 12 falls within the specific region SA1. When the arm 12 can take a plurality of types of postures in order to be arranged at a target position of the end effector 13, the specific region SA1 may be defined by the type of posture. For example, the specific region SA1 may be defined by being an elbow-up type posture in which an elbow of the arm 12 is convex upward, or being an elbow-down type posture in which an elbow of the arm 12 is convex downward. For example, when a posture of the arm 12 is the elbow-up type, the selection unit 114 may determine that the robot 10 operates within the specific region SA1 and select the characteristic information SC1. Conversely, when a posture of the arm 12 is the elbow-down type, the selection unit 114 may determine that the robot 10 operates within the specific region SA1 and select the characteristic information SC1.

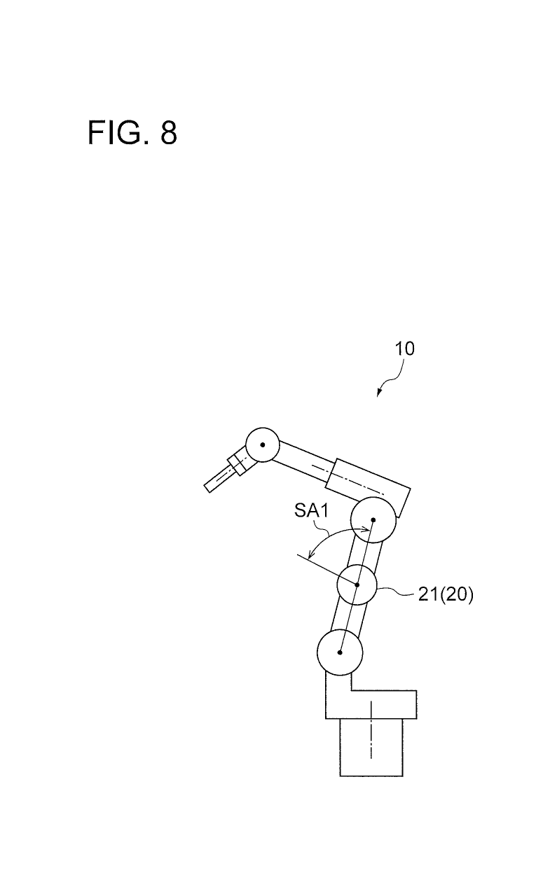

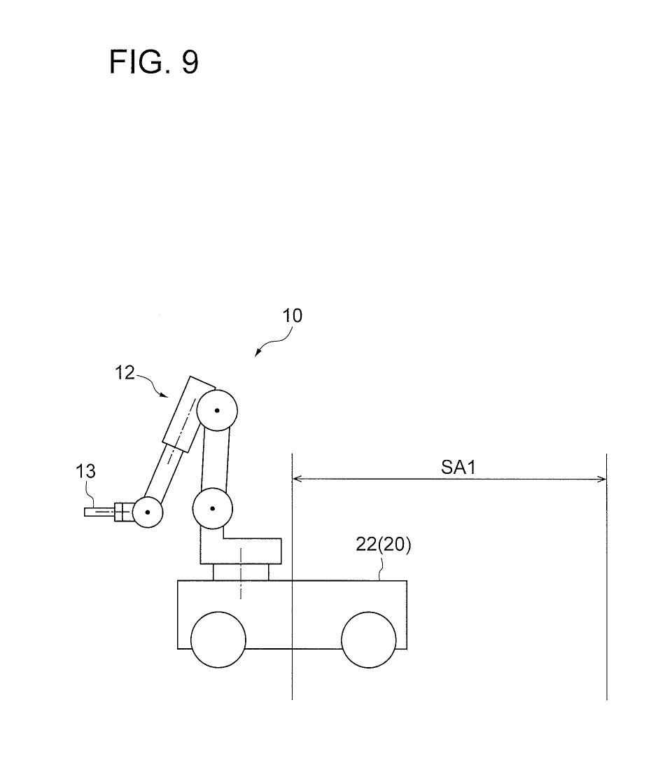

As shown in FIGS. 8-9, the robot 10 may have a redundant degree of freedom 20 that enables changing a posture of the arm 12 without changing a position and a posture of the end effector 13. The redundant degree of freedom 20 is a degree of freedom that enables freely changing the angles of the plurality of joints 14 corresponding to the position and posture of the end effector 13 without being limited to a finite number of solutions (for example, the plurality of types of postures described above). The specific region SA1 may be defined by a state of the redundant degree of freedom 20. The selection unit 114 may select the characteristic information SC1 when a state of the redundant degree of freedom 20 falls within the specific region SA1. The state of the redundant degree of freedom 20 may have a large influence on a motion error. In this case, the specific region SA1 is defined by the redundant degree of freedom 20, and the characteristic information SC1 is selected when the state of the redundant degree of freedom 20 falls within the specific region SA1, whereby the motion error of the robot 10 can be easily reduced.

For example, as shown in FIG. 8, the robot 10 may have a redundant axis 21 as the redundant degree of freedom 20, and the specific region SA1 may be represented by an angle of the redundant axis 21. As shown in FIG. 9, the robot 10 may be an AMR having an automated guided vehicle 22 as the redundant degree of freedom 20, and the specific region SA1 may be represented by a position of the automated guided vehicle 22.

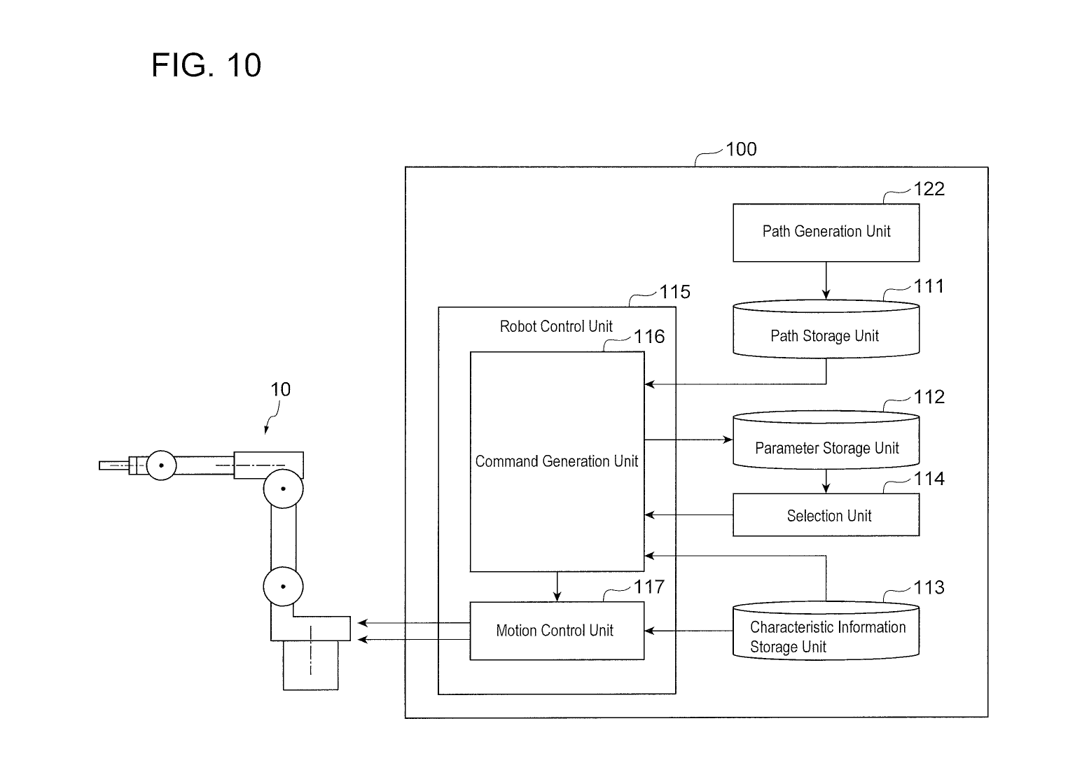

As shown in FIG. 10, the robot controller 100 may further have a path generation unit 122. The path generation unit 122 generates a motion path of the robot 10 based on surrounding environment information. The selection unit 114 may select the characteristic information SC1 when the robot 10 according to a motion path belongs to the specific region SA1. Even in an operation newly generated adapting to a surrounding environment, a motion error is reduced based on the characteristic information SC1 in the specific region SA1. Therefore, it is possible to easily perform generating an operation adapted to a surrounding environment without considering a motion error.

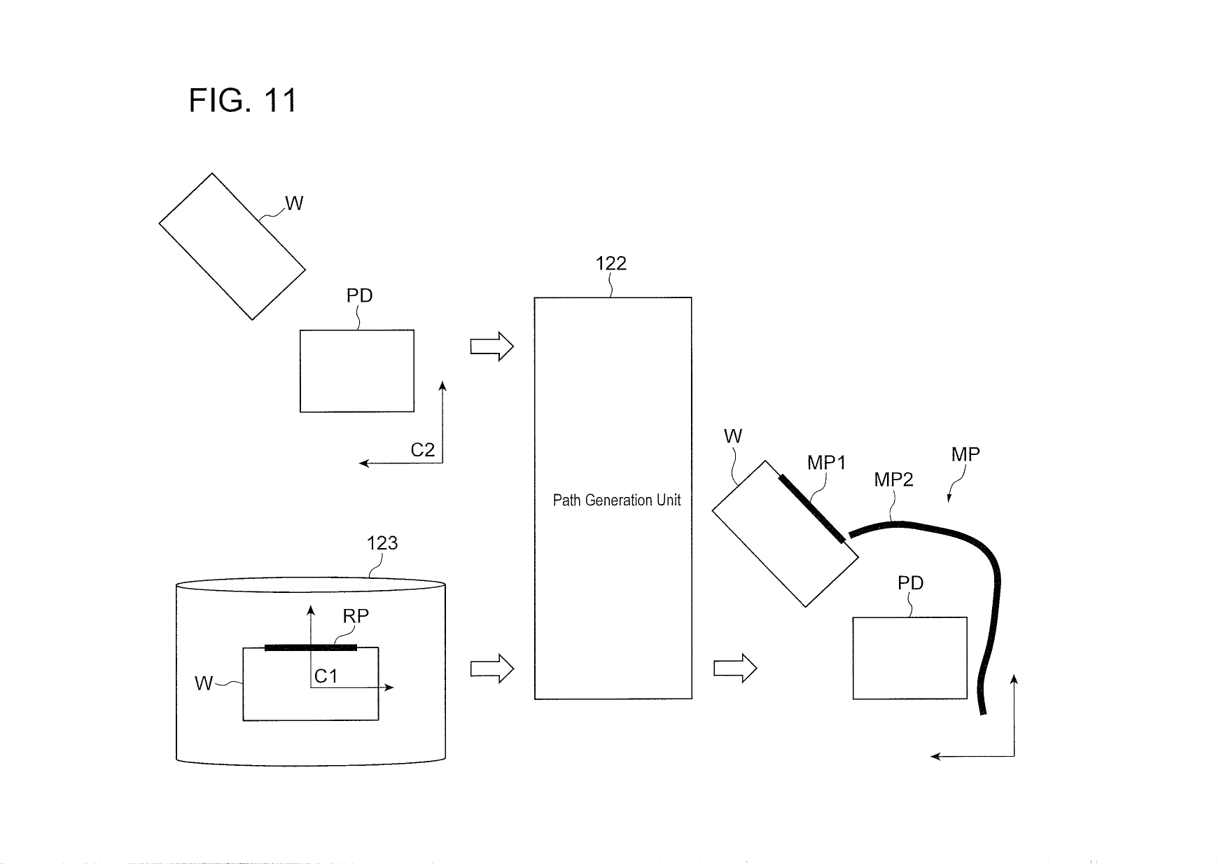

Generating a motion path includes fitting a relative path defined in advance with reference to a position of a workpiece W to an actual position of the workpiece W (an example of a surrounding environment). For example, as shown in FIG. 11, the robot controller 100 may further have a relative path storage unit 123. The relative path storage unit 123 stores a relative path RP representing a motion path with reference to a position of a workpiece W. For example, the relative path RP is defined in a workpiece coordinate system C1 (a coordinate system fixed to a workpiece W). For example, a relative path is represented by a plurality of motion commands in chronological order. Each of the plurality of motion commands in the relative path includes a target position expressed in the workpiece coordinate system C1. Hereinafter, a target position expressed in the workpiece coordinate system C1 is referred to as a "relative target position".

The path generation unit 122 may generate a motion path of the robot 10 based on surrounding environment information including a position of a workpiece W and the relative path RP. The surrounding environment information may include a position of a peripheral device PD in addition to the position of the workpiece W. For example, the path generation unit 122 generates a motion path MP by performing coordinate transformation of each relative target position of a plurality of motion commands of the relative path RP into a target position in a robot coordinate system C2 (a coordinate system fixed to the base 11) based on a position of a workpiece W (including a posture of the workpiece W), and stores it in the path storage unit 111. By being based on a relative path RP prepared in advance, operation generation adapted to a surrounding environment can be performed more easily.

The relative path storage unit 123 may store a relative path RP for each of a plurality of types of tasks. The path generation unit 122 may generate a motion path MP based on a relative path RP corresponding to a task commanded from an upper controller or the like.

The path generation unit 122 may be configured to generate a motion path MP including a motion path MP2 for moving to a start position of a task motion path MP1, in addition to the task motion path MP1 corresponding to a relative path RP. For example, the path generation unit 122 may generate a moving motion path MP2 by simulating a motion of the robot 10 based on surrounding environment information. For example, the path generation unit 122 may generate a moving motion path MP2 so as to move the end effector 13 to a start position of a task motion path MP1 while avoiding collision with a workpiece W and a peripheral device PD by simulation. The selection unit 114 may control the robot 10 so as to reduce a motion error based on the characteristic information SC1 in both of a case where a task motion path MP1 of the robot 10 falls within a specific region SA1 and a case where a moving motion path MP2 of the robot 10 falls within a specific region SA1.

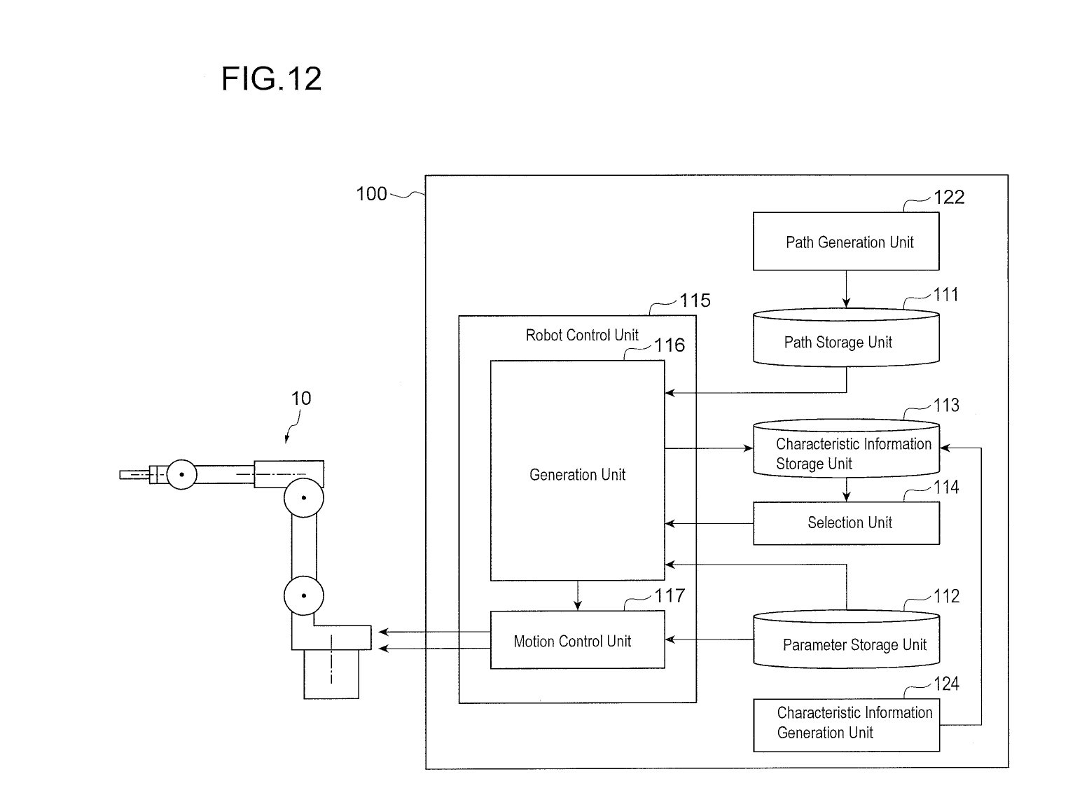

As shown in FIG. 12, the robot controller 100 may further have a characteristic information generation unit 124 (generation unit). The characteristic information generation unit 124 generates the characteristic information SC1 based on an actual measurement result of a motion error in the specific region SA1. The characteristic information SC1 can be easily generated in a usage environment of the robot 10. The actual measurement result of a motion error includes information representing a posture of the robot 10 when the motion error is actually measured (for example, angles of each of a plurality of joints 14). The characteristic information generation unit 124 generates characteristic information based on a relationship between a posture of the robot 10 and a motion error.

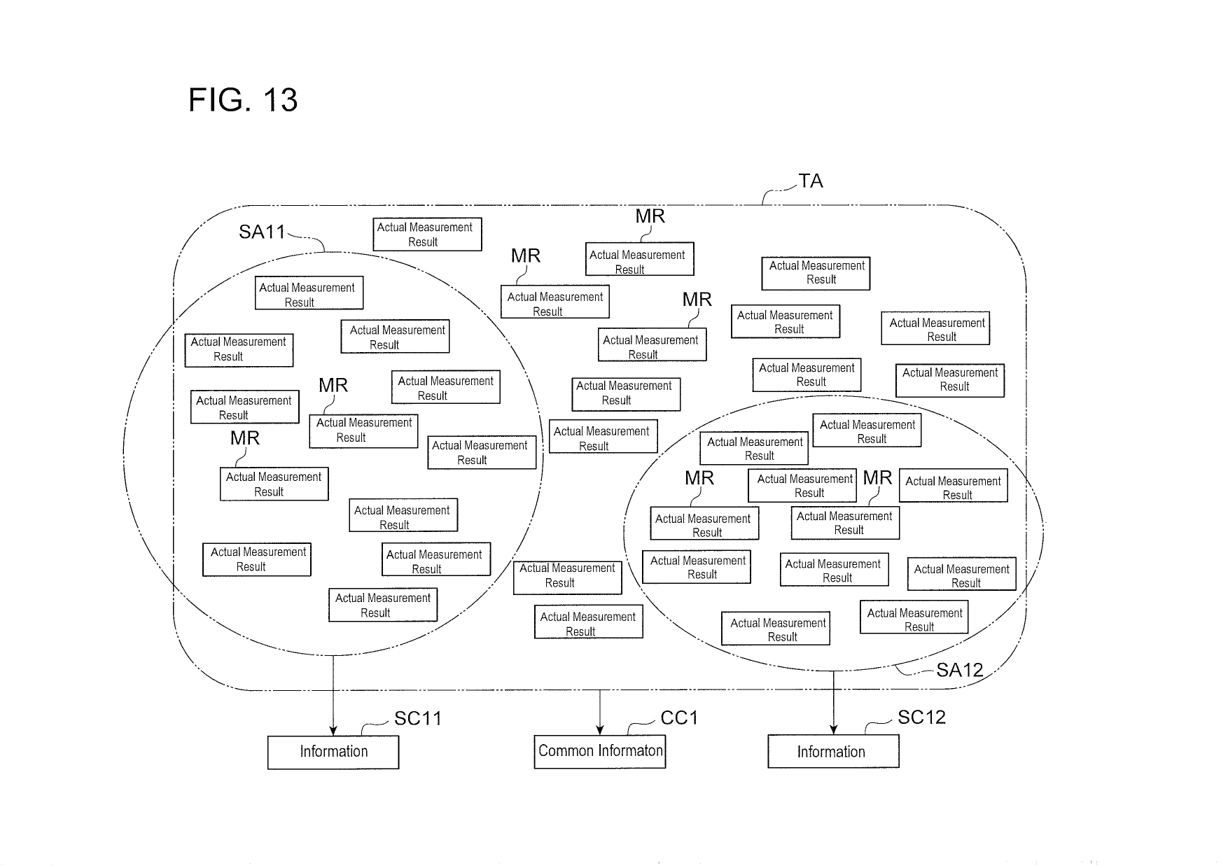

For example, as shown in FIG. 13, the characteristic information generation unit 124 may generate characteristic information SC11 based on an actual measurement result MR acquired in a specific region SA1 (for example, operating region SA11) among a plurality of actual measurement results MR acquired in a detection target region TA of a device that actually measures a motion error. The characteristic information generation unit 124 may generate characteristic information SC12 based on an actual measurement result MR acquired in another specific region SA2 (for example, operating region SA12) different from the specific region SA1. Furthermore, the characteristic information generation unit 124 may generate common information CC1 based on all actual measurement results MR acquired in the detection target region TA.

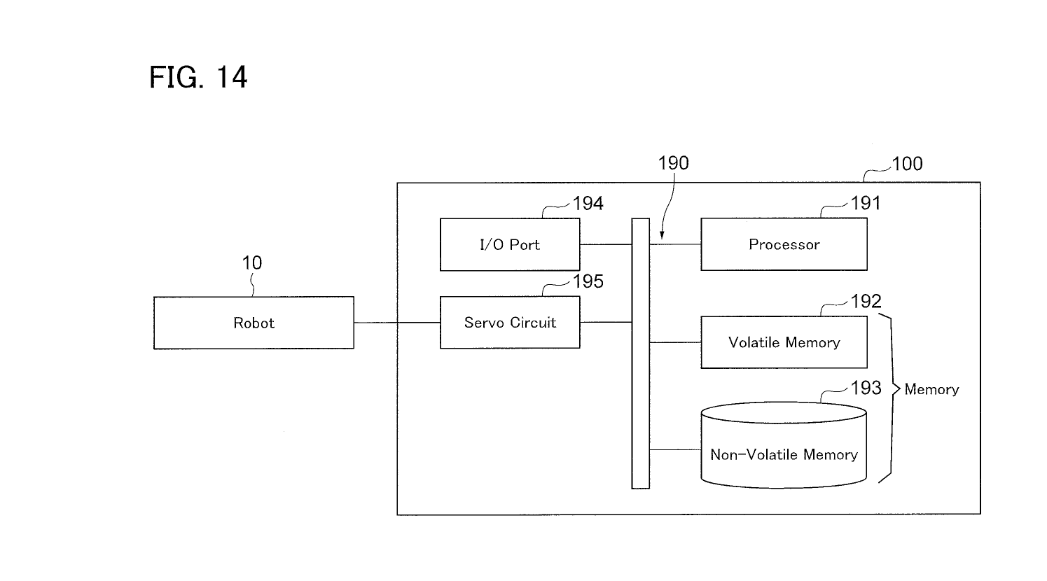

FIG. 14 is a block diagram illustrating a hardware configuration of the robot controller 100. As shown in FIG. 14, the robot controller 100 has a circuit 190. The circuit 190 has a processor 191, a volatile memory 192, a non-volatile memory (a storage) 193, an input/output port 194, and a servo circuit 195. Therefore, the robot controller 100 stores a program for causing the robot controller 100 to execute storing first information representing a structural characteristic of the arm 12 in a first operating region, selecting the first information when the robot 10 operates within the first operating region, and operating the robot 10 so as to reduce a motion error based on the selected first information. For example, the storage 193 stores a program for configuring the above-described functional blocks in the robot controller 100. The storage 193 includes one or more non-volatile storage devices. Examples of the non-volatile storage device include a hard disk drive, a flash memory, an optical disk drive, a read-only memory, and the like.

The volatile memory 192 temporarily stores a program loaded from the storage 193. The volatile memory 192 includes one or more volatile storage devices. Examples of the volatile storage devices include a random access memory and the like. The processor 191 configures the above-described functional blocks in the robot controller 100 by executing a program loaded into the volatile memory 192. The processor 191 includes one or more arithmetic devices. An example of an arithmetic device includes a CPU (Central Processing Unit) and the like.

The input/output port 194 performs input/output of information with the above-described device or the like for actually measuring a motion error based on a request from the processor 191. The servo circuit 195 supplies a driving power for each of the plurality of joints 14 to the robot 10 based on a request from the processor 191.

### Control Procedure

As an example of a control method, a control procedure executed by the robot controller 100 is exemplified. This control procedure includes storing first information representing a structural characteristic of the arm 12 that becomes a factor of a motion error of the robot 10 in a first operating region in association with the first operating region of the robot 10, selecting the first information when the robot 10 operates within the first operating region, and operating the robot 10 so as to reduce the motion error based on the selected first information.

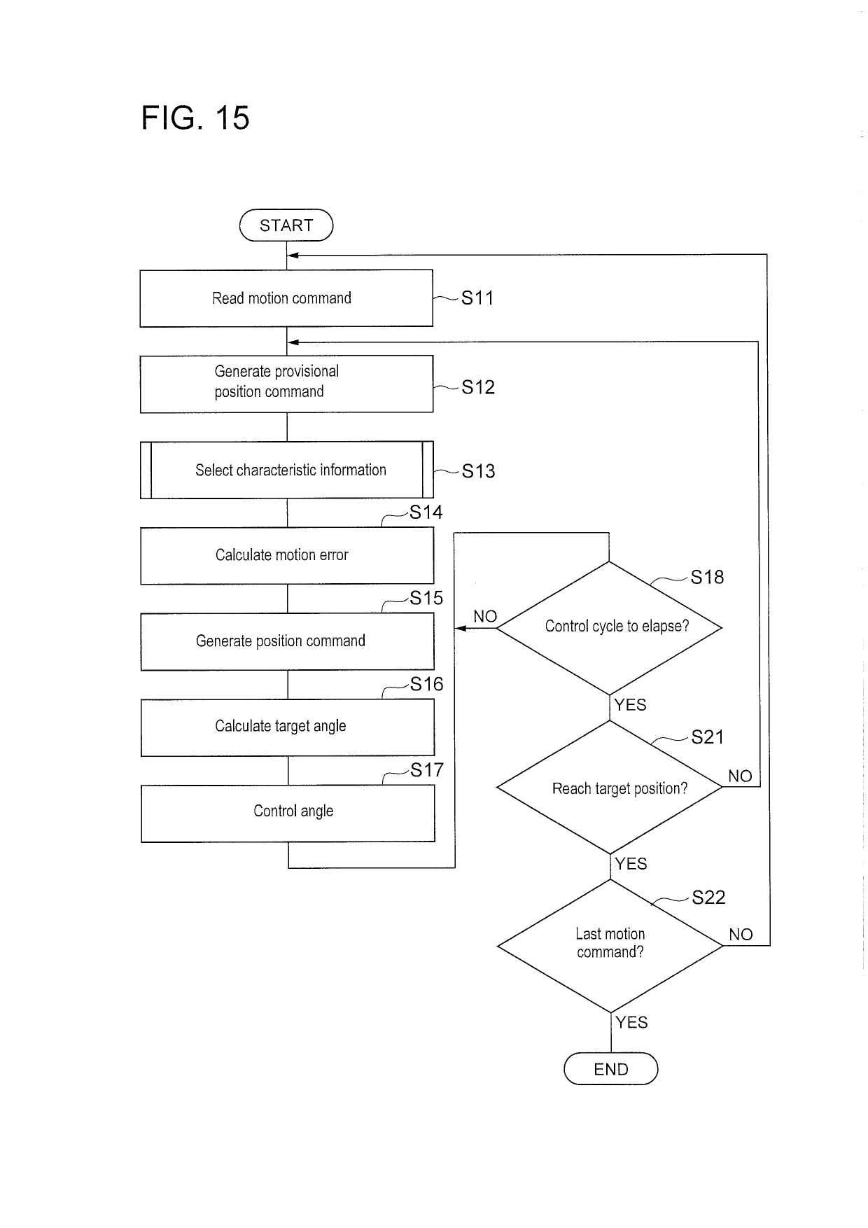

For example, as shown in FIG. 15, the robot controller 100 executes steps S11 and S12 in order. In step S11, the command generation unit 116 reads a motion command from the path storage unit 111. In step S12, the command generation unit 116 generates the above-described provisional position command based on the motion command.

Next, the robot controller 100 executes step S13. In step S13, the selection unit 114 selects any piece of information stored in the parameter storage unit 112 based on the operating region within which the robot 10 operates. The details of step S13 will be described later.

Next, the robot controller 100 executes steps S14, S15, S16, S17, and S18 in order. In step S14, the command generation unit 116 calculates a motion error based on the information selected in step S13. In step S15, the command generation unit 116 generates a position command so as to reduce the motion error based on the provisional position command calculated in step S12 and the motion error calculated in step S14. In step S16, the motion control unit 117 calculates a target angle of each joint 14 corresponding to the position command calculated in step S15. In step S17, the motion control unit 117 causes the angle of each joint 14 to track the target angle. In step S18, the command generation unit 116 waits for a control cycle to elapse.

Next, the robot controller 100 executes step S21. In step S21, the command generation unit 116 checks whether or not the end effector 13 has reached a target position of the motion command. When it is determined in step S21 that the end effector 13 has not reached the target position, the robot controller 100 returns the process to step S12. Thereafter, generation of a position command and control based on a position command are repeated at a control cycle until the target position is reached.

When it is determined in step S21 that the end effector 13 has reached the target position, the robot controller 100 executes step S22. In step S22, the command generation unit 116 checks whether or not execution of the last motion command has been completed. When it is determined in step S22 that an unexecuted motion command remains, the robot controller 100 returns the process to step S11. Thereafter, reading out of a motion command and control based on a motion command are repeated until the last motion command is executed. When it is determined in step S22 that execution of the last motion command has been completed, the robot controller 100 completes the process.

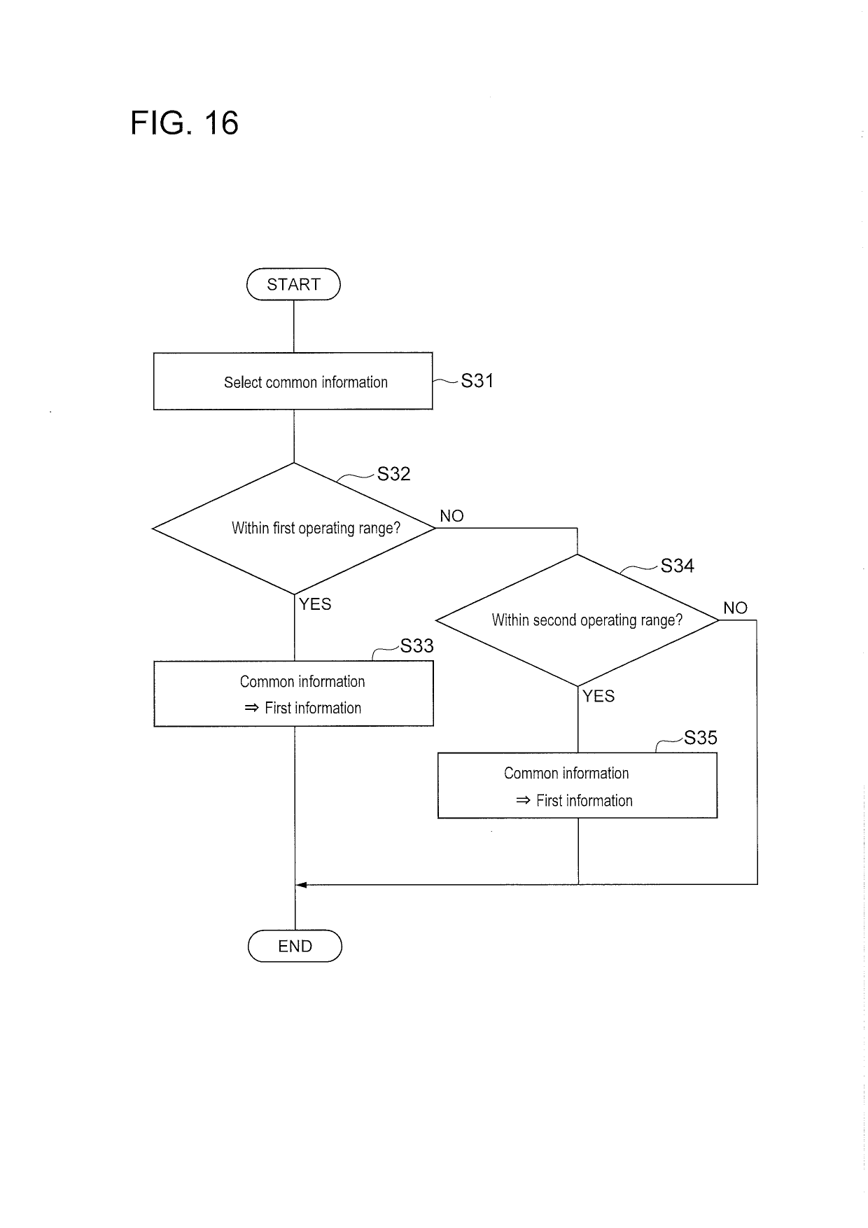

FIG. 16 is a flowchart illustrating a selection procedure in step S13. As shown in FIG. 16, the robot controller 100 executes step S31. In step S31, the selection unit 114 selects the above-described common information CC1.

Next, the robot controller 100 executes step S32. In step S32, the selection unit 114 checks whether or not the robot 10 operates within a specific region SA1 (for example, operating region SA11). When it is determined in step S32 that the robot 10 operates within a specific region SA1, the robot controller 100 executes step S33. In step S33, the selection unit 114 selects characteristic information SC1 (for example, characteristic information SC11) corresponding to the specific region SA1.

When it is determined in step S32 that the robot 10 does not operate within the specific region SA1, the robot controller 100 executes step S34. In step S34, the selection unit 114 checks whether or not the robot 10 operates within another specific region SA1 (for example, operating region SA12). When it is determined in step S34 that the robot 10 operates within another specific region SA1, the robot controller 100 executes step S35. In step S35, the selection unit 114 selects characteristic information SC1 (for example, characteristic information SC12) corresponding to the other specific region SA1. With the above, the selection procedure is completed. The above procedure exemplifies a case where the specific region SA1 is two regions, which are an operating region SA11 and an operating region SA12. In a case where three or more specific regions SA1 exist, checking whether or not the robot 10 operates within it, and selecting characteristic information SC1 when the robot 10 operates within it, are executed for each of the three regions.

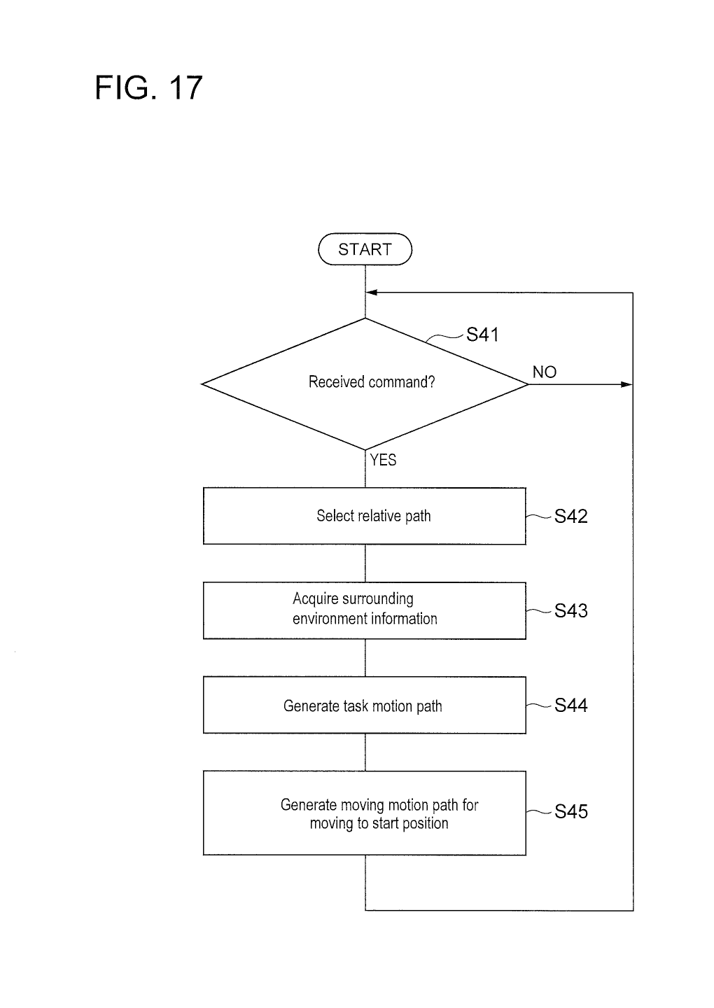

As described above, the robot controller 100 may be configured to further execute generating a motion path based on surrounding environment information. The generation of a motion path is executed prior to the above-described control procedure. FIG. 17 is a flowchart illustrating a generation procedure of a motion path. As shown in FIG. 17, the robot controller 100 first executes step S41. In step S41, the path generation unit 122 waits for an execution command of a task from an upper controller or the like.

Next, the robot controller 100 executes steps S42, S43, S44, and S45. In step S42, the path generation unit 122 selects a relative path RP of a task corresponding to an execution command from the relative path storage unit 123. In step S43, the path generation unit 122 acquires surrounding environment information from an upper controller or the like. In step S44, the path generation unit 122 generates a task motion path MP1 by fitting a relative path RP to a position of a workpiece W based on the relative path RP and the position of the workpiece W included in the surrounding environment information. In step S45, the path generation unit 122 generates a moving motion path MP2 for moving the end effector 13 to a start position of a task motion path MP1, based on the surrounding environment information. Thereafter, the robot controller 100 returns the process to step S41. The robot controller 100 repeatedly executes the above processes.

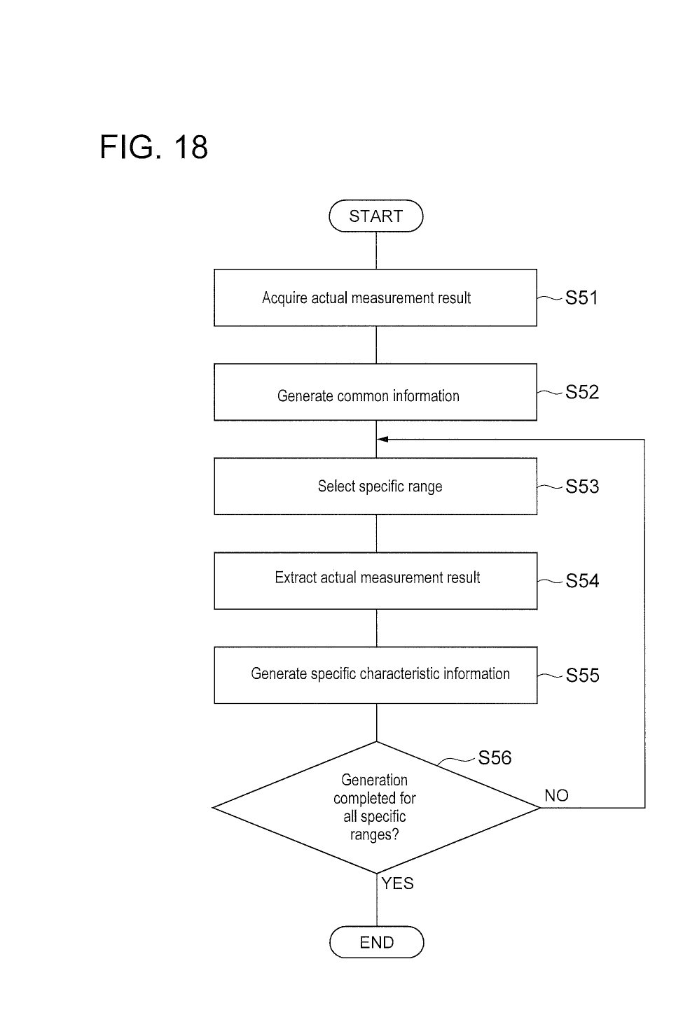

As described above, the robot controller 100 may be configured to generate characteristic information based on an actual measurement result of a motion error. The generation of characteristic information is executed prior to the above-described control procedure. FIG. 18 is a flowchart illustrating a generation procedure of characteristic information. As shown in FIG. 18, the robot controller 100 first executes steps S51 and S52 in order. In step S51, the characteristic information generation unit 124 acquires an actual measurement result of a motion error in a detection target region TA. In step S52, the characteristic information generation unit 124 generates common information CC1 based on an actual measurement result of a motion error in a detection target region TA.

Next, the robot controller 100 executes steps S53, S54, and S55. In step S53, the characteristic information generation unit 124 selects any specific region SA1. In step S54, the characteristic information generation unit 124 extracts an actual measurement result included in a specific region SA1. In step S55, the characteristic information generation unit 124 generates characteristic information SC1 of a specific region SA1 based on the extracted actual measurement result.

Next, the robot controller 100 executes step S56. In step S56, the characteristic information generation unit 124 checks whether or not generation of characteristic information SC1 has been completed for all specific regions SA1. When it is determined in step S56 that a specific region SA1 for which characteristic information SC1 has not been generated remains, the robot controller 100 returns the process to step S53. Thereafter, selecting a specific region SA1 and generating characteristic information SC1 are repeated until generation of characteristic information SC1 is completed for all specific regions SA1. When it is determined in step S56 that generation of characteristic information SC1 has been completed for all specific regions SA1, the robot controller 100 completes the generation of characteristic information.

### SUMMARY

The present disclosure described above includes the following configurations.
(1) A robot system 1 comprising a robot 10 having an arm 12 configured to change a position of an end effector 13, a storage unit 113 configured to store first information SC11 representing a structural characteristic of the arm 12 that becomes a factor of a motion error of the robot 10 in a predetermined first operating region SA11, in association with the first operating region SA11, a selection unit 114 configured to select the first information SC11 when the robot 10 operates within the first operating region SA11, and a control unit 115 configured to operate the robot 10 so as to reduce the motion error, based on the first information SC11 selected by the selection unit 114. According to the robot system 1, a motion error in the first operating region SA11 can be further reduced by using information specialized for the first operating region SA11 for the first operating region SA11.
(2) The robot system 1 according to (1), wherein the storage unit 113 further stores second information SC12 representing a structural characteristic of the arm 12 that becomes a factor of a motion error in a second operating region SA12 different from the first operating region SA11 in addition to the first information SC11, the selection unit 114 configured to select the first information SC11 when the robot 10 operates within the first operating region SA11, and selects the second information SC12 when the robot 10 operates within the second operating region SA12, and the control unit 115 configured to operate the robot 10 so as to reduce a motion error based on the first information SC11 or the second information SC12 selected by the selection unit 114. According to the robot system 1, even when a structural characteristic of the arm 12 changes depending on an operating region (for example, when there is nonlinearity in a structural characteristic of the arm 12), a motion error in the first operating region SA11 can be further reduced based on the first information SC11 for the first operating region SA11, and a motion error in the second operating region SA12 can be further reduced based on the second information SC12 for the second operating region SA12.
(3) The robot system 1 according to (1) or (2), wherein the storage unit 113 further stores common information CC1 representing a structural characteristic of the arm 12 that becomes a factor of a motion error of the robot 10 in addition to the first information SC11, the selection unit 114 switches information to be selected from the common information CC1 to the first information SC11 when the robot 10 operates within the first operating region SA11, and the control unit 115 switches from a state of operating the robot 10 so as to reduce a motion error based on the common information CC1 to a state of operating the robot 10 so as to reduce a motion error based on the first information SC11 when the information to be selected is switched from the common information CC1 to the first information SC11 by the selection unit 114. According to the robot system 1, a motion error of the robot 10 can be reduced in a wider region by applying the common information CC1 to an operating region not associated with specific information.
(4) The robot system 1 according to any one of (1) to (3), wherein the first operating region SA11 is defined by a position of the end effector 13, and the selection unit 114 selects the first information SC11 when a position of the end effector 13 falls within the first operating region SA11. The position of the end effector 13 may have a large influence on a motion error. In this case, a motion error of the robot 10 can be easily reduced by defining a predetermined operating region by a position of the end effector 13 and selecting information when a position of the end effector 13 falls within a predetermined operating region.
(5) The robot system 1 according to any one of (1) to (4), wherein the first operating region SA11 is defined by a posture of the end effector 13, and the selection unit 114 selects the first information SC11 when a posture of the end effector 13 falls within the first operating region SA11. The posture of the end effector 13 may have a large influence on a motion error. In this case, a motion error of the robot 10 can be easily reduced by defining a predetermined operating region by a posture of the end effector 13 and selecting information when a posture of the end effector 13 falls within a predetermined operating region.
(6) The robot system 1 according to any one of (1) to (5), wherein the first operating region SA11 is defined by a posture of the arm 12, and the selection unit 114 selects the first information SC11 when a posture of the arm 12 falls within the first operating region SA11. The posture of the arm 12 may have a large influence on a motion error. In this case, a motion error of the robot 10 can be easily reduced by defining a predetermined operating region by a posture of the arm 12 and selecting information when a posture of the arm 12 falls within a predetermined operating region.
(7) The robot system 1 according to any one of (1) to (6), wherein the robot 10 has a redundant degree of freedom 20 that enables changing a posture of the arm 12 without changing a position and a posture of the end effector 13, the first operating region SA11 is defined by a state of the redundant degree of freedom 20, and the selection unit 114 selects the first information SC11 when a state of the redundant degree of freedom 20 falls within the first operating region SA11. The state of the redundant degree of freedom 20 may have a large influence on a motion error. In this case, a motion error of the robot 10 can be easily reduced by defining a predetermined operating region by the redundant degree of freedom 20 and selecting information when a state of the redundant degree of freedom 20 falls within a predetermined operating region.
(8) The robot system 1 according to any one of (1) to (7), wherein the arm 12 is configured to change a position of the end effector 13 relative to a base, the first operating region SA11 is defined by a distance from the base to the end effector 13, and the selection unit 114 selects the first information SC11 when a distance from the base to the end effector 13 falls within the first operating region SA11. The distance from the base to the end effector 13 may have a large influence on a motion error. In this case, a motion error of the robot 10 can be easily reduced by defining a predetermined operating region by a distance from the base to the end effector 13 and selecting information when a distance from the base to the end effector 13 falls within a predetermined operating region.
(9) The robot system 1 according to (8), wherein the first operating region SA11 is defined by a distance from a vertical axis passing through the base to the end effector 13, and the selection unit 114 selects the first information SC11 when a distance from a vertical axis passing through the base to the end effector 13 falls within the first operating region SA11. The distance from a vertical axis passing through the base to the end effector 13 may have a large influence on a motion error. In this case, a motion error of the robot 10 can be easily reduced by defining a predetermined operating region by a distance from a vertical axis passing through the base to the end effector 13 and selecting information when a distance from a vertical axis passing through the base to the end effector 13 falls within a predetermined operating region.
(10) The robot system 1 according to (8) or (9), wherein the first operating region SA11 is defined by a height of the end effector 13 relative to the base, and the selection unit 114 selects the first information SC11 when a height of the end effector 13 relative to the base falls within the first operating region SA11. The height of the end effector 13 relative to the base may have a large influence on a motion error. In this case, a motion error of the robot 10 can be easily reduced by defining a predetermined operating region by a height of the end effector 13 relative to the base and selecting information when a height of the end effector 13 relative to the base falls within a predetermined operating region.
(11) The robot system 1 according to any one of (1) to (10), wherein the first information SC11 includes information indicating compliance of the arm 12 in the first operating region SA11. By using compliance specialized for the first operating region SA11, a motion error in the first operating region SA11 can be further reduced even when there is nonlinearity in compliance.
(12) The robot system 1 according to any one of (1) to (11), further comprising a path generation unit 122 that generates a motion path of the robot 10 based on surrounding environment information representing a state of a surrounding environment of the robot 10, wherein the selection unit 114 selects the first information SC11 when a motion path of the robot 10 falls within a predetermined first operating region SA11. Even in an operation newly generated adapting to a surrounding environment, a motion error is reduced based on information in a predetermined operating region. Therefore, it is possible to easily perform generating operation adapted to a surrounding environment without considering a motion error.
(13) The robot system 1 according to (12), further comprising a relative path storage unit 123 that stores a relative path representing a motion path with reference to a position of a workpiece that is a task target by the end effector 13, wherein the path generation unit 122 generates the motion path of the robot 10 based on surrounding environment information including a position of a workpiece and a relative path. Generating operation adapted to a surrounding environment can be performed more easily.
(14) The robot system 1 according to any one of (1) to (13), further comprising a generation unit 124 that generates the first information SC11 based on an actual measurement result of a motion error in the first operating region SA11. The above information can be easily generated in a usage environment of the robot 10.
(15) A control method including: storing first information SC11 representing a structural characteristic of an arm 12 that becomes a factor of a motion error of a robot 10 in a first operating region SA11, in association with the first operating region SA11 of the robot 10 having the arm 12 configured to change a position of an end effector 13; selecting the first information SC11 when the robot 10 operates within the first operating region SA11; and operating the robot 10 so as to reduce a motion error based on the selected first information SC11.

operating region

What is claimed is:

1. A robot system comprising:
a robot having an arm configured to change a position of an end effector;
a processor; and
a memory storing:
first information representing a structural characteristic of the arm that causes a motion error of the robot in a first operating region; and
instructions that when executed by the processor, cause the processor to perform operations comprising controlling the robot so as to reduce the motion error based on the first information when the robot operates within the first operating region.

2. The robot control system according to claim 1,
wherein the first information is associated with the first operating region in the memory,
wherein the memory further stores second information in association with a second operating region different from the first operating region, the second information representing a structural characteristic of the arm that causes the motion error in the second operating region, and
wherein the operations further comprise
selecting the first information when the robot operates within the first operating region,
selecting the second information when the robot operates within the second operating region, and
controlling the robot so as to reduce the motion error based on the first information or the second information that has been selected.

3. The robot control system according to claim 1,
wherein the memory further stores common information representing a structural characteristic of the arm that causes a motion error of the robot in an undefined operating region, and
wherein the operations further comprise controlling the robot so as to reduce the motion error based on the common information when the robot does not operate within the first operating region.

4. The robot control system according to claim 1,
wherein the memory further stores common information representing a structural characteristic of the arm that causes a motion error of the robot in an undefined operating region, and
wherein the operations further comprise controlling the robot so as to reduce the motion error based on the common information when the robot operates neither within the first operating region nor within the second operating region.

5. The robot system according to claim 1,
wherein the first operating region is defined by a position of the end effector, and
wherein the robot is controlled so as to reduce the motion error based on the first information when the position of the end effector falls within the first operating region.

6. The robot system according to claim 1,
wherein the first operating region is defined by a posture of the end effector, and
wherein the robot is controlled so as to reduce the motion error based on the first information when the posture of the end effector falls within the first operating region.

7. The robot system according to claim 1,
wherein the first operating region is defined by a posture of the arm, and
wherein the robot is controlled so as to reduce the motion error based on the first information when the posture of the arm falls within the first operating region.

8. The robot system according to claim 1,
wherein the robot has a redundant degree of freedom to enable changing a posture of the arm without changing a position and a posture of the end effector,
wherein the first operating region is defined by a state of the redundant degrees of freedom, and
wherein the robot is controlled so as to reduce the motion error based on the first information when the state of the redundant degree of freedom falls within the first operating region.

9. The robot system according to claim 1,
wherein the arm is configured to change a position of the end effector relative to a base,
wherein the first operating region is defined by a reference distance from the base to the end effector, and
wherein the robot is controlled so as to reduce the motion error based on the first information when the reference distance falls within the first operating region.

10. The robot system according to claim 9,
wherein the reference distance is defined by a distance from a vertical axis passing through the base to the end effector.

11. The robot system according to claim 9,
wherein the reference distance is defined by a height of the end effector relative to the base.

12. The robot system according to claim 1, wherein the first information includes information indicating compliance of the arm in the first operating region.

13. The robot system according to claim 1,
wherein the operations further comprise generating a motion path of the robot based on a surrounding environment of the robot, and
wherein the robot is controlled so as to reduce the motion error based on the first information when the motion path of the robot falls within the first operating region.

14. The robot system according to claim 13,
wherein the memory further stores a relative path representing the motion path with reference to a position of a workpiece to be manipulated by the end effector, and
wherein the motion path of the robot is generated based on the surrounding environment information including a position of the workpiece and the relative path.

15. The robot system according to claim 1,
wherein the operations further comprise generating the first information based on an actual measurement result of the motion error in the first operating region.

16. The robot system according to claim 2,
wherein the first operating region is defined by a position of the end effector, and
wherein the robot is controlled so as to reduce the motion error based on the first information when the position of the end effector falls within the first operating region.

17. The robot system according to claim 3,
wherein the first operating region is defined by a position of the end effector, and
wherein the robot is controlled so as to reduce the motion error based on the first information when the position of the end effector falls within the first operating region.

18. The robot system according to claim 4,
wherein the first operating region is defined by a position of the end effector, and
wherein the robot is controlled so as to reduce the motion error based on the first information when the position of the end effector falls within the first operating region.

19. A computer-implemented control method comprising:
reading first information from a memory, the first information representing a structural characteristic of an arm of a robot that causes a motion error of the robot in a first operating region; and
controlling the robot so as to reduce the motion error based on the first information when the robot operates within the first operating region.

20. A robot system comprising:
a robot having an arm configured to change a position of an end effector;
storage means for storing first information representing a structural characteristic of the arm that causes a motion error of the robot in a first operating region; and
control means for controlling the robot so as to reduce the motion error based on the first information when the robot operates within the first operating region.
